(19) United States
(12) Patent Application Publication
(10) Pub. No.: US 2024/0421304 A1
(43) Pub. Date: Dec. 19, 2024

(54) NEGATIVE PLATE, SECONDARY BATTERY AND ELECTRICAL DEVICE

(71) Applicant: CALB Group Co., Ltd., Jiangsu (CN)

(72) Inventors: Dexiang Guo, Jiangsu (CN); Taotao Shen, Jiangsu (CN); Zhi Qiao, Jiangsu (CN); Xuyi Shan, Henan (CN)

(73) Assignee: CALB Group Co., Ltd., Jiangsu (CN)

(21) Appl. No.: 18/677,833

(22) Filed: May 29, 2024

(30) Foreign Application Priority Data
Jun. 14, 2023 (CN) 202310702058.X

(51) Int. Cl. H01M 4/583; H01M 4/02

(52) U.S. Cl. CPC H01M 4/583; H01M 2004/021; H01M 2004/027

(57) ABSTRACT

A negative plate, a secondary battery and an electrical device, which fall within the technical field of batteries, wherein the negative plate includes a negative current collector and an anode active material layer provided on a surface of the negative current collector, the anode active material layer includes an anode active material, the anode active material includes graphite, and the negative plate satisfies the following relationship: a=ln(D_{FW})+10×ln(D_{V}50)+⅓(La)+26.5, b=PD, a/45−b≥0.05. By reasonably controlling a particle diameter distribution of the anode active material in the negative plate, as well as a crystal size and a compacted density of the negative plate, the negative plate of the present disclosure maintains good wettability at a higher compacted density and has good liquid absorption capacity for an electrolyte solution, and a battery containing the negative plate has excellent cycle life.

### CROSS-REFERENCE TO RELATED APPLICATION

This application claims the priority benefit of Chinese application serial no. 202310702058.X, filed on Jun. 14, 2023. The entirety of the above-mentioned patent application is hereby incorporated by reference herein and made a part of this specification.

### TECHNICAL FIELD

The present disclosure relates to the technical field of batteries, and more particularly, to a negative plate, a secondary battery and an electrical device.

### BACKGROUND

In recent years, with the continuous development and popularization of electric vehicles, the requirements for the battery performance of electric vehicles are becoming higher and higher, and especially the current endurance mileage issues are receiving more and more attention. Battery is the core component of electric vehicles, and energy density of battery is one of the key factors to determine the endurance mileages of electric vehicles, so that improving the energy density of battery is very critical.

As reported in the prior art, the energy density of battery can be increased by increasing a compacted density of the plates. However, the increase in the compacted density of the plates also causes other problems, such as a decrease in the low-temperature liquid absorption capacity (wettability) of the plates, which also decreases the cycle life of the battery.

Accordingly, it would be desirable to provide a plate having both high compacted density and good wettability.

### SUMMARY

The present disclosure provides a negative plate, a secondary battery, and an electrical device, wherein the negative plate has a higher compacted density, maintains a good low-temperature wettability, and has a good liquid absorption capacity for an electrolyte solution at a low temperature, and a battery including the negative plate has an excellent cycle life.

In a first aspect of the present disclosure, the present disclosure provides a negative plate, including a negative current collector and an anode active material layer provided on at least one surface of the negative current collector, the anode active material layer including an anode active material, wherein the anode active material includes graphite, and the negative plate satisfies the following relationship:

$$a = ln ( {D}_{F W} ) + 10 \times ln ( {D}_{V} 50 ) + 1 / 3 ( L a ) + 26.5 , b = P D , a / 45 - b \geq 0.05 ,$$

where D_{FW} is a full width at half maximum of a particle size volume distribution of the anode active material in a unit of μm,
D_{V}50 is a particle diameter corresponding to 50% of a cumulative volume distribution percentage of the anode active material in a unit of μm,
La is an average size of a crystal in an a-axis direction measured by Raman spectroscopy on the negative plate in a unit of nm, and
PD is a compacted density of the negative plate in a unit of g/cm³.

As a preferred implementation of the present disclosure, the negative plate satisfies the following relationship: 0.06≤a/45−b≤0.15.

As a preferred implementation of the present disclosure, the D_{FW} is in a range of 10 μm to 35 μm.

As a further preferred implementation of the present disclosure, the D_{FW} is in a range of 15 μm to 30 μm.

As a preferred implementation of the present disclosure, the D_{V}50 is in a range of 5 μm to 20 μm.

As a further preferred implementation of the present disclosure, the D_{V}50 is in a range of 8 μm to 15 μm.

As a preferred implementation of the present disclosure, the La is in a range of 50 nm to 80 nm.

As a further preferred implementation of the present disclosure, the La is in a range of 65 nm to 75 nm.

As a preferred implementation of the present disclosure, the PD is in a range of 1.3 g/cm³ to 1.8 g/cm³.

As a further preferred implementation of the present disclosure, the PD is in a range of 1.60 g/cm³ to 1.75 g/cm³.

As a preferred implementation of the present disclosure, the negative plate further satisfies the following relationship:

$$9.5 \leq 5.5 \times b - ln ( c ) \leq 11.5 ,$$

where c is an ion transport impedance of the negative plate in a unit of ohms (Ω).

As a preferred implementation of the present disclosure, the c is in a range of 0.05Ω to 2Ω.

In a second aspect of the present disclosure, the present disclosure provides a secondary battery, including a positive plate, a negative plate and an electrolyte solution, wherein the negative plate is the negative plate described above.

In a third aspect of the present disclosure, the present disclosure provides an electrical device including the secondary battery described above.

### DETAILED DESCRIPTION

In order to make the purpose, technical solutions, and advantages of the embodiments of the present disclosure clearer, the technical solutions in the embodiments of the present disclosure will be described clearly and completely below. Obviously, the described embodiments are a part, not all, of the embodiments of the present disclosure. Based on the embodiments of the present disclosure, all other embodiments obtained by a person skilled in the art without involving any inventive effort fall within the scope of protection of the present disclosure.

In the present disclosure, among the technical features which are described in an open manner, a closed technical solution consisting of the recited features also includes an open technical solution containing the recited features.

In the present disclosure, reference is made to numerical ranges which are, unless otherwise indicated, to be considered continuous and to include both the minimum and maximum values of the range, and every value between the minimum and maximum values. Further, when a range refers to an integer, every integer between the minimum and maximum values of the range is included. Further, when multiple ranges are provided to describe a feature or characteristic, the ranges can be combined. In other words, unless otherwise indicated, all ranges disclosed herein are to be understood to include any and all subranges subsumed therein.

In the present disclosure, the specific dispersion and stirring treatment methods are not particularly limited.

The reagents or instruments used in the present disclosure, without indicating the manufacturer, are conventional products commercially available.

The present disclosure has developed a negative plate, a secondary battery including the same and an electrical device. By reasonably controlling a particle diameter distribution of the anode active material in the negative plate, as well as a crystal size and a compacted density of the negative plate, the negative plate of the present disclosure maintains good low-temperature wettability at a higher compacted density and has good liquid absorption capacity for an electrolyte solution at a low temperature, and a battery containing the negative plate has excellent cycle life.

### Negative Plate

An embodiment of the present disclosure provides a negative plate, including a negative current collector and an anode active material layer provided on at least one surface of the negative current collector, the anode active material layer including an anode active material, wherein the anode active material includes graphite the negative plate satisfies the following relationship:

$$a = ln ( {D}_{F W} ) + 10 \times ln ( {D}_{V} 50 ) + 1 / 3 ( L a ) + 26.5 , b = P D , a / 45 - b \geq 0 \text{.05} ;$$

where D_{FW} is a full width at half maximum of a particle size volume distribution of the anode active material in a unit of μm,
D_{V}50 is a particle diameter corresponding to 50% of a cumulative volume distribution percentage of the anode active material in a unit of μm,
La is an average size of a crystal in an a-axis direction measured by Raman spectroscopy on the negative plate in a unit of nm, and
PD is a compacted density of the negative plate in a unit of g/cm³.

D_{FW} and D_{V}50 represent a particle diameter distribution of the anode active material in the negative plate, and La represents an average size of a crystal in an a-axis direction (referred to as transverse crystal size) on a microscopic scale of the negative plate. In the present disclosure, a=ln(D_{FW})+10×ln(D_{V}50)+⅓(La)+26.5, that is, a size of the value of a is related to the combination of D_{FW}, D_{V}50 and La, so that morphology features of the negative plate on both the macro-and micro-scale can be combined. When a/45−b≥0.05, the morphology feature and compacted density of the negative plate are in a suitable range, which is not only conducive to lithium ions entering a graphite layer through defects and can freely lead to intercalation and deintercalation of lithium ions, but also is conducive to the wetting of the electrolyte solution and the anode active material, and a thickness of the SEI film generated by the reaction is controlled in a certain range, so that the negative plate has excellent liquid absorption capacity for the electrolyte solution at a low temperature and has good wettability, and the battery containing the negative plate has a high cycle life.

In one of the implementations, the negative plate satisfies the following relationship:

$$0.06 \leq a / 45 - b \leq 0.15 .$$

In one of the more preferred implementations, the negative plate satisfies the following relationship: 0.08≤a/45−b≤0.12.

With the increase of a/45−b, the low-temperature wettability of negative plate is better. However, the value of a/45−b should not be too high, which may cause a decrease in an energy density of the battery or impair a charge/discharge rate of the battery.

In the present disclosure, D_{FW} is a full width at half maximum of a particle size volume distribution of the anode active material, that is, the difference between the two particle diameter values corresponding to a half of a maximum height of an interval particle diameter distribution curve of the anode active material. The interval particle diameter distribution (also referred to as differential distribution of the particle diameter) curve of the anode active material is a well-known meaning in the art, and is defined as a curve drawn with the particle diameter as an abscissa and a volume percentage content as an ordinate, which can more accurately reflect a particle diameter distribution characteristics of anode active material particles.

D_{V}50 is a particle diameter corresponding to 50% of a cumulative volume distribution percentage of the anode active material. With regard to the method for detecting D_{FW} and D_{V}50, the present disclosure is not limited, and a person skilled in the art would have been able to detect D_{FW} and D_{V}50 of the anode active material according to conventional technical means, and, by way of example, a laser particle size analyzer, such as a Master sizer 3000 laser particle size analyzer of Malvern Panalytical Ltd. (UK) could be adopted.

A particle diameter control of the anode active material (including a regulation of D_{FW} and D_{V}50) generally uses a grading screening method, and a specific grading screening method is not particularly limited and can be selected according to actual situations. Sieve grading screening is typically used. The anode active material is thrown into sieves with different mesh grades of screening. Since the particle diameters of the particles are different, the particles with a small particle diameter will be screened out by the sieves, and the desired particle diameters can be retained on the sieves, and thereby the anode active material with different particle diameter grades can be obtained. Active substances of certain particle diameter dimensions can be formulated according to actual needs so that their particle diameter distribution can be adjusted manually.

In one of the implementations, the D_{FW} is in a range of 10 μm to 35 μm, and is for example, 12 μm, 15 μm, 18 μm, 20 μm, 25 μm, 30 μm, 33 μm.

In one of the preferred implementations, the D_{FW} is in a range of 15 μm to 30 μm.

In one of the implementations, the D_{V}50 is in a range of 5 μm to 20 μm, and is for example, 7 μm, 8 μm, 10 μm, 11 μm, 13 μm, 15 μm, 18 μm.

In one of the preferred implementations, the D_{V}50 is in a range of 8 μm to 15 μm.

When the D_{FW} is within the above-mentioned preferred range of the present disclosure, the anode active material has a relatively wide range of particle diameter distribution and particles of a large size and particles of a small size are mixed, so as to achieve an increase in the compacted density of the negative electrode plate without decreasing the low-temperature wettability of the negative plate. When the D_{V}50 of the anode active material is larger, the negative plate can obtain a higher compacted density, which contributes to the improvement of electrochemical performance of the battery. However, the D_{V}50 should not be so large as to cause uneven distribution of the anode active material layer or decrease the cycle life of the battery.

In the present disclosure, the La value of the negative plate is measured by Raman spectroscopy and calculated by the following formula: La=2.4×10⁻¹⁰×λ⁴×(A_{D}/A_{G})⁻¹, where λ is a wavelength of an incident light in the Raman spectrum, A_{D} is a peak area of a D peak (located in a waveband region of 1320 cm⁻¹ to 1380 cm⁻¹) in the Raman spectrum and A_{G} is a peak area of a G peak (located in a waveband region of 1560 cm⁻¹ to 1600 cm⁻¹) in the Raman spectrum.

The La of the negative plate is the La in a state where the anode active material is contained in an anode active coating of the negative plate. As well known, the anode active coating is prepared by mixing raw materials including the anode active material, a binder, a conductive material, etc. with a solvent to prepare a slurry, coating the slurry on a current collector, and drying and rolling the same. The La of the anode active material will change during the preparation process, so it is necessary to clearly distinguish the physical properties of the anode active material in a raw material state and the anode active material in an anode active coating state. The two cannot be considered as equivalent. Once the anode active material is uniformly distributed and solidified onto the negative plate, its crystallite size is basically stable during the use of the battery. However, in order to regularly control initial grain defects of the negative active material, the negative active material may be graphite which have been subjected to thermal processing, namely, in particular, the graphite material is subjected to a thermal processing under inert conditions, i.e. in an atmosphere substantially free of oxygen, including but not limited to an atmosphere of an inert gas (e.g. nitrogen, argon, etc.). After thermal processing under inert conditions, the quantity of defects, dislocation slips or discontinuities in the graphite grains can be reduced, thereby adjusting the regularity of the graphite crystals. Conditions conventional in the art may be employed for thermal processing of the graphite material.

The above-mentioned thermal processing for graphite is not an essential step in the present disclosure, and the technical problem of the present disclosure can also be solved if the anode active material, satisfying the above-mentioned relationship range, in the anode active coating can be obtained by mass screening and after specific control of preparation conditions.

In one of the implementations, the La is in a range of 50 nm to 80 nm, and is such as 55 nm, 59 nm, 65 nm, 67 nm, 69 nm, 72 nm, 75 nm, 79 nm.

In one of the preferred implementations, the La is in a range of 65 nm to 75 nm.

When the La value of the negative plate is too small, a crystallinity of the anode active material is relatively low and a capacity is small, which limits the improvement of energy density of the lithium ion battery; when the La value of the negative plate is too large, a diffusion distance after lithium ions are intercalated into the anode active material layer is lengthened, resulting in an increase in diffusion resistance and easy lithium precipitation during high-rate charging and discharging, thereby reducing the cycle life of the battery.

In one of the implementations, the PD is in a range of 1.3 g/cm³ to 1.8 g/cm³, and is for example, 1.35 g/cm³, 1.4 g/cm³, 1.45 g/cm³, 1.5 g/cm³, 1.6 g/cm³, 1.65 g/cm³, 1.7 g/cm³, 1.75 g/cm³.

In one of the preferred implementations, the PD is in a range of 1.60 g/cm³ to 1.75 g/cm³.

The compacted density of the negative plate represents the degree of compaction between substances in the anode active material layer. Generally, the compacted density is related to the energy density of the material, and at an excessively low compacted density, the energy density of the battery is low. Therefore, it is preferred in this patent that the PD of the negative plate is not less than 1.3 g/cm³. Further, the inventors have found that when the PD is in a range of 1.60 g/cm³ to 1.75 g/cm³, and the negative plate has both a high compacted density and an excellent low-temperature wetting performance.

In one of the implementations, the negative plate further satisfies the relationship: 9.5≤5.5×b−ln(c)≤11.5, where c is an ion transport impedance (Rᵢₒₙ) of the negative plate in a unit of ohms (Ω). The ion transport impedance Rᵢₒₙ of the negative plate can be measured as follows: a symmetrical battery is prepared with two identical negative plates, the electrochemical impedance spectroscopy (EIS) of the symmetrical battery is acquired by using electrochemical workstation, and alternating current impedance spectra are obtained by EIS test. An impedance composition is analyzed by combining an equivalent circuit diagram and an impedance decomposition model, and the Nyquist diagram and the bode diagram are obtained. The Z-view or EC-Lab software is used for fitting, and a coincidence degree between a simulation diagram and a measured diagram is improved by adjusting the values of the various impedances. Calculation is performed according to the following formula to obtain Rᵢₒₙ: Z′_{107 →0}=Rₛₒₗ−Rᵢₒₙ/3, where Rₛₒₗ is an ohmic impedance, Z′_{ω→0} is a mixed impedance, the values of Rₛₒₗ and Z′_{ω→0} can be obtained according to the Nyquist diagram of EIS (refer to the detection method in this document: Ogihara N, Kawauchi S, Okuda C, et al. Theoretical and experimental analysis of porous electrodes for lithium-ion batteries by electrochemical impedance spectroscopy using a symmetric cell[J]. Journal of The Electrochemical Society, 2012, 159(7): A1034.).

When the ion transport impedance and the compacted density of the negative plate meet 9.5≤5.5×b−ln(c)≤11.5, the ion transport impedance and the compacted density are in an appropriate range, and the battery has good electrochemical performance and excellent low-temperature wetting performance.

In one of the implementations, the c is in a range of 0.05Ω to 2Ω, and is for example, 0.1Ω, 0.15Ω, 0.2Ω, 0.3Ω, 0.4Ω, 0.5Ω, 0.6Ω, 0.8Ω, 1.0Ω, 1.5Ω, 1.8Ω.

In one of the preferred implementations, c is in the range of 0.1Ω to 1.0Ω.

The ion transport impedance reflects a transport rate of electrolyte ions in electrode channels. Generally speaking, when the ion transport impedance is low, the transport rate of electrolyte ions is relatively high, which helps the electrolyte solution to better wet the plate at a low temperature. The ion transport impedance of the negative plate is affected by various factors, such as a porosity, a pore structure of the anode active material layer, the morphology feature of the anode active material, etc. Although the wetting performance of the negative plate is better when the ion transport impedance is lower, the performance of the negative plate may be unstable to achieve a lower ion transport impedance, thereby causing a decrease in the cycle life of the battery.

The graphite in the anode active material according to the present disclosure may include natural graphite and/or artificial graphite.

The method for preparing the anode active material is not particularly limited in the present disclosure, and a person skilled in the art can prepare the anode active material by conventional means.

Illustratively, the method for preparing the anode active material may be as follows:
crushing and granulating a graphite raw material to obtain a granular product; subjecting the granular product to a graphitization treatment at a temperature of 2500° C. to 3500° C. for a time period of 5 h to 8 h, controlling a gradient temperature rise during the graphitization treatment, for example, heating at a rate of 5° C./min to 20° C./min; then performing carbonization treatment at a temperature of 700° C. to 1500° C. for a time period of 4 h to 8 h to obtain an artificial graphite; and obtaining the anode active material through screening and grading;
the method for preparing the anode active material may also be as follows:
adopting natural graphite ore to obtain natural flake graphite through crushing, ball milling and flotation, and performing isostatic pressing after screening, acid washing treatment and spheronization treatment, wherein the conditions for the isostatic pressing are: a temperature of 100° C. to 300° C. and a pressure of 70 Mpa to 85 MPa and a time for 30 min to 180 min; after mixing the obtained product with a coating material, performing a carbonization treatment at a temperature of 700° C. to 1300° C. for a time period of 5 h to 7 h; and obtaining the anode active material through screening and grading;
therein, alternatively, the coating material may be a high-purity asphalt, and a mixing mass ratio of the isostatically pressed product to the coating material is (97-99):(1-3).

As for the negative plate, the present disclosure does not particularly limit the negative current collector as long as it has high conductivity without causing adverse chemical changes in the battery, and for example, copper, stainless steel, aluminum, nickel, titanium, carbon fired, copper or stainless steel surface-treated with one of carbon, nickel, titanium, silver, or the like, or an aluminum-cadmium alloy may be used.

The anode active material layer of the negative plate may further include a conductive agent, a binder, in addition to the anode active material.

The conductive agent functions to improve the electrical conductivity of the anode active material layer, and the present disclosure has no particular limitation on the conductive agent, for example, carbon powder such as carbon black, acetylene black, ketjen black, channel black, furnace black, lamp black or thermal black, graphite powder such as natural graphite or artificial graphite, conductive fiber such as carbon fiber or metal fiber; conductive whiskers such as zinc oxide whiskers or potassium titanate whiskers can be used.

The binder serves to enhance adhesion between the conductive agent, the anode active material, and the negative current collector. The binder is not particularly limited in the present disclosure, and for example, a polymer material such as a fluororesin-based binder, a rubber-based binder, a cellulose-based binder, a polyol-based binder, a polyolefin-based binder, a polyimide-based binder, a polyester-based binder, a silane-based binder, or the like may be used.

In addition, a thickener, which may use carboxymethyl cellulose, may be further included in the anode active material layer.

It should be noted that the method for preparing the negative plate is not particularly limited in the present disclosure, and a person skilled in the art would have been able to prepare the negative plate according to conventional methods.

Illustratively, the method for preparing the negative plate may be as follows:
coating an anode slurry, which may be prepared by dissolving or dispersing the anode active material and optionally the binder and the conductive agent in the solvent with the negative current collector, followed by rolling or drying; or
performing the preparation by casting the anode slurry on a separate carrier and then laminating a membrane separated from the carrier on the negative current collector.

### Secondary Battery

An embodiment of the present disclosure provides a secondary battery, including a positive plate, a negative plate and an electrolyte solution, wherein the negative plate is the negative plate described above.

The positive plate of the present disclosure includes a positive current collector and a cathode active material layer provided on at least one surface of the positive current collector, wherein the cathode active material layer includes a cathode active material, and may further includes a conductive agent and/or a binder.

The present disclosure does not particularly limit the positive current collector as long as it has high conductivity without causing adverse chemical changes in the battery, and for example, copper, stainless steel, aluminum, nickel, titanium, carbon fired, copper or stainless steel surface-treated with one of carbon, nickel, titanium, silver, or the like, or an aluminum-cadmium alloy may be used. The positive current collector may be the same as or different from the negative current collector of the present disclosure.

The cathode active material is a compound capable of being reversibly intercalated and deintercalated with lithium, and for example, the cathode active material may include a lithium composite metal oxide including lithium and at least one metal selected from the group consisting of nickel (Ni), cobalt (Co), manganese (Mn), iron (Fe), and aluminum (Al). Specifically, the cathode active material may include at least one of Li(Ni_{0.6}Mn_{0.2}Co_{0.2})O₂, Li(Ni_{0.7}Mn_{0.2}Co_{0.10})O₂, Li(Ni_{0.8}Mn_{0.1}Co_{0.1})O₂, Li(Ni_{0.8}Co_{0.15}Al_{0.05})O₂, Li(Ni_{0.86}Mn_{0.07}Co_{0.05}Al_{0.02})O₂, Li(Ni_{0.9}Mn_{0.05}Co_{0.05})O₂.

The conductive agent functions to improve the electrical conductivity of the cathode active material layer, and the present disclosure does not particularly limit the conductive agent. The conductive agent in the positive plate may be the same as or different from the conductive agent in the negative plate of the present disclosure.

The binder serves to enhance adhesion between the conductive agent, the cathode active material, and the positive current collector, and the present disclosure does not particularly limit the binder. The binder in the positive plate may be the same as or different from the binder in the negative plate of the present disclosure.

It should be noted that the method for preparing the positive plate is not particularly limited in the present disclosure, and a person skilled in the art would have been able to prepare the positive plate according to conventional methods.

Illustratively, the method for preparing the positive plate may be as follows:
coating a cathode slurry, which may be prepared by dissolving or dispersing the cathode active material and optionally the binder and the conductive agent in the solvent with the positive current collector, followed by rolling or drying; or
performing the preparation by casting the cathode slurry on a separate carrier and then laminating a membrane separated from the carrier on the positive current collector.

The electrolyte solution of the present disclosure may be any electrolyte solution suitable in the art for use in electrochemical energy storage devices. The electrolyte solution includes an electrolyte and a solvent, and the electrolyte may generally include a lithium salt, and more specifically, the lithium salt may be an inorganic lithium salt and/or an organic lithium salt. The solvent in the electrolyte solution is generally a non-aqueous solvent, and specifically, the solvent includes at least one of ethylene carbonate, propylene carbonate, butylene carbonate, pentylene carbonate, dimethyl carbonate, diethyl carbonate, dipropyl carbonate, methyl ethyl carbonate, or a halogenated derivatives thereof.

The secondary battery may further include a separator disposed between the positive plate and the negative plate for spacing the positive plate and the negative plate and preventing the positive plate and the negative plate from contacting and short-circuiting. The separator can be any of a variety of materials known in the art suitable for use as a spacing separator for electrochemical energy storage devices. Specifically, the separator includes at least one of polyethylene, polypropylene, polyvinylidene fluoride, aramid, polyethylene terephthalate, polytetrafluoro ethylene, polyacrylonitrile, polyimide, polyamide, polyester, and natural fiber.

### Electrical Device

One implementation of the present disclosure provides an electrical device including the secondary battery described above. The secondary battery serves as a power supply for the electrical device.

The electrical device refers to any device that can use electrical energy and convert same into one or more forms of energy such as mechanical energy, thermal energy, light energy, etc., for example, an electric motor, an electric heat engine, an electric light source, etc. Specifically, it can include but is not limited to mobile devices, electric vehicles, electric trains, ships and satellites, energy storage systems, etc., mobile devices can include mobile phones, laptops, UAVs, sweeping robots, e-cigarettes, etc; electric vehicles can include pure electric vehicles, hybrid electric vehicles, plug-in hybrid electric vehicles, electric bicycles, electric scooters, electric golf carts, electric trucks, etc.

The disclosure is further illustrated in combination with the following specific examples.

In particular embodiments of the present disclosure, the method for detecting D_{V}50 and D_{FW} of the anode active material is as follows:
performing measurements using a laser particle size test method using a Malvern particle size tester according to the following steps: dispersing the anode active material to be tested in deionized water containing a dispersant (such as nonylphenol polyoxyethylene ether with a content of 0.03 wt %) to form a mixture, sonicating the mixture for 2 minutes, and then placing same into a particle size tester for testing; obtaining the D_{FW} from a difference between the two particle diameter values corresponding to a half of the maximum height of the interval particle diameter distribution curve of the active material, and obtaining the D_{V}50 from the particle diameter corresponding to 50% of the cumulative volume distribution percentage of the anode active material.

In particular embodiments of the present disclosure, the method for detecting La of the negative plate is as follows:
obtaining the La of the negative plate through test analysis by Thermo Fisher Raman spectrometer, and calculating the La by the following formula: La=2.4×10⁻¹⁰×λ⁴×(A_{D}/A_{G})⁻¹ wherein λ is a wavelength of an incident laser light of Raman spectrum, A_{D} is a peak area of D peak (located in a waveband region of 1320 cm⁻¹ to 1380 cm⁻¹) in Raman spectrum and A_{G} is a peak area of G peak (located in a waveband region of 1560 cm⁻¹ to 1600 cm⁻¹) in Raman spectrum; and the Raman spectroscopy analysis conditions are as follows: using a laser light with a wavelength of 785 nm and a spot of less than 1 μm² at room temperature and under normal atmospheric pressure.

In particular embodiments of the present disclosure, the method for detecting PD of the negative plate is as follows:
compacted density of the negative plate PD=m/V, where, in the formula, m is the mass of anode active material layer in a unit of g, and m can be weighed using an electronic balance with an accuracy of 0.01 g or more; Visa volume of the anode active material layer in a unit of cm³, wherein the volume V is the product of the area Ar of the anode active material layer and the thickness of the anode active material layer, and the thickness can be measured using a spiral micrometer with an accuracy of 0.5 μm.

In particular embodiments of the present disclosure, the method for detecting Rᵢₒₙ of the negative plate is as follows:
preparing a symmetrical battery by using two identical negative plates, measuring the alternating current impedance of the symmetrical battery using an electrochemical workstation, and collecting an electrochemical impedance spectroscopy (EIS) of the symmetrical battery, wherein the specific test conditions are as follows: sinusoidal alternating current voltage excitation with an amplitude of 5 mV and a frequency range of 0.1 Hz to 10⁶ Hz; obtaining the Nyquist diagram and bode diagram based on the equivalent circuit diagram and impedance decomposition model, and then fitting by Z-view or EC-Lab software, then improving the coincidence degree between the simulated diagram and the measured diagram by adjusting the values of the various impedances to obtain the ion transport impedance Rᵢₒₙ of ions in the plate. In particular embodiments of the present disclosure, the method for detecting a contact angle is as follows:
with ethylene carbonate and methyl ethyl carbonate (weight ratio is 1:1) as a solvent, detecting the contact angle of the negative plate using a contact angle tester JC2000 D2M manufactured by Shanghai Zhongchen Digital Technology Equipment Co. Ltd. (powereach), wherein the specific detection conditions are as follows: keeping the negative plate in an environment of −10° C. for 30 minutes, then dropping the solvent drop by drop at different positions on the surface of the negative plate (one drop at each position), using a contact angle tester to observe the moment when the drop completely contacts the plate, calculating the contact angle at this moment, and taking an average value according to the test results at different positions, namely, the contact angle of the negative plate.

In particular embodiments of the present disclosure, the method for detecting a compacted state is as follows:
observing the surface of the negative plate after the rolling treatment, wherein: if there is no abnormality on the surface after rolling, there is good surface; if, within 5 cm of an edge of the negative plate, there are one or more stripes or spots with a darker color, and there is no abnormality in other areas, there is an edge overpressure; and if, in addition to the edge of the negative plate, there are one or more stripes or spots with a darker color in a middle area, there is a severe overpressure.

In particular embodiments of the present disclosure, the method for detecting the cycle life is as follows:
using a battery charge/discharge tester to make charge/discharge cycle test on the lithium ion battery at 25° C., and the charge/discharge system is as follows: charging the battery with 1 C of constant current to 4.25V, then charging the battery with constant voltage until the current drops to 0.02 C, after standing for 5 min, discharging the battery with 1C of constant current to 2.5V, which is 1 cycle; as the battery cycles, the battery capacity decays, and the quantity of cycles experienced when the capacity decays to 80% of a first discharge capacity is recorded as the cycle life of the battery.

### Embodiment 1

This embodiment provides a lithium ion battery, and the specific preparation method is as follows:

### (1) Preparation of the Negative Plate:

(1.1) A mechanical mill or a roller mill is used to crush the raw material non-needle-shaped raw petroleum coke, and grading is performed after crushing so as to regulate the particle diameter distribution of the obtained particle product; after shaping the granular product obtained after crushing, the granular product obtained is added into a reaction kettle of a granulator, and granulation treatment is performed without adding a binder; the product obtained by granulation is added into a graphitization furnace and graphitization treatment is performed under the conditions that: the temperature is maintained at 2800° C. for 3 h and then increased to 3300° C. at 15° C./min for 3 h; then a carbonization treatment is performed at a temperature of 1020° C. for a time period of 8 h, and pressure is not additionally applied in the carbonization treatment, thereby obtaining an artificial graphite; then the artificial graphite is screened and graded by a grading sieve to obtain the anode active material with a D_{V}50 of 12 μm and a D_{FW} of 25.1 μm;

(1.2) the anode active material, the conductive agent (carbon black), the thickener (carboxymethyl cellulose, CMC) and the binder (styrene-butadiene rubber, SBR) are mixed in a mass ratio of 95:1.5:1.5:2.0, a vacuum stirrer is used to prepare the anode slurry in a wet process, the anode slurry is uniformly coated on the negative current collector (copper foil), the negative current collector coated with the anode slurry is transferred to an oven for drying, then rolling and slitting are performed, and the rolling conditions are controlled to obtain the negative plate having a PD of 1.68 g/cm³.

### (2) Preparation of the Positive Plate

the cathode active material Li(Ni_{0.7}Mn_{0.2}Co_{0.1})O₂, the binder (polyvinylidene fluoride) and the conductive agent (carbon black) are mixed in a mass ratio of 95:2.5:2.5, N-methylpyrrolidone (NMP) is added, and stirring is performed under the action of a vacuum stirrer until the mixed system forms the cathode slurry with uniform fluidity; the cathode slurry is uniformly coated on the positive current collector (aluminum foil); the positive current collector coated with the cathode slurry is transferred to an oven for drying, and then subjected to rolling and slitting to obtain the positive plate.

### (3) Preparation of the Electrolyte Solution

Ethylene carbonate (EC) and ethyl methyl carbonate (EMC) are mixed in a ratio of 1:1 by weight to obtain an organic solvent, and then sufficiently dried lithium salt LiPF₆ is dissolved in the mixed organic solvent to prepare the electrolyte solution with a concentration of 1 mol/L.

### (4) Preparation of Separator

A polyethylene (PE) separator coated with ceramic and polyvinylidene fluoride is used.

### (5) Preparation of the Battery

The prepared positive plate, separator and negative plate are wound to obtain a bare cell without liquid injection; the bare cell is paced in an outer packaging foil, the above-mentioned prepared electrolyte solution is injected into the dried bare cell, and the lithium ion battery is obtained through vacuum packaging, standing, formation, shaping, sorting and other processes.

### Embodiment 2

Embodiment 2 provides a lithium ion battery, the method for preparing which is substantially the same as that of Embodiment 1, except that:
in preparing the negative plate, the conditions for the graphitization treatment are as follows: the temperature is maintained at 2790° C. for 2 h, and then the temperature is increased to 2900° C. by 10° C./min and maintained for 4 h; and for the carbonization treatment, the temperature is 1000° C. and the time period is 6 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 3

Embodiment 3 provides a lithium ion battery, the method for preparing which is substantially the same as that of Embodiment 1, except that:
in preparing the negative plate, the conditions for the graphitization treatment are as follows: the temperature is maintained at 2815° C. for 3 h, and then the temperature is increased to 2950° C. by 13° C./min and maintained for 3 h; and for the carbonization treatment, the temperature is 830° C. and the time period is 4.5 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 4

Embodiment 4 provides a lithium ion battery, the method for preparing which is substantially the same as that of Embodiment 1, except that:
in preparing the negative plate, the conditions for the graphitization treatment are as follows: the temperature is maintained at 3025° C. for 4 h, and then the temperature is increased to 3200° C. by 10° C./min and maintained for 2 h; and for the carbonization treatment, the temperature is 850° C. and the time period is 4 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 5

Embodiment 5 provides a lithium ion battery, the method for preparing which is substantially the same as that of Embodiment 1, except that:
in preparing the negative plate, the conditions for the graphitization treatment are as follows: the temperature is maintained at 3000° C. for 3 h, and then the temperature is increased to 3150° C. by 15° C./min and maintained for 3.5 h; and for the carbonization treatment, the temperature is 800° C. and the time period is 7.5 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 6

Embodiment 6 provides a lithium ion battery, the method for preparing which is substantially the same as that of Embodiment 1, except that:
in preparing the negative plate, the conditions for the graphitization treatment are as follows: the temperature is maintained at 2830° C. for 2.5 h, and then the temperature is increased to 3000° C. by 20° C./min and maintained for 3.5 h; and for the carbonization treatment, the temperature is 1000° C. and the time period is 7.5 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 7

Embodiment 7 provides a lithium ion battery, the method for preparing which is substantially the same as that of Embodiment 1, except that:
in preparing the negative plate, the conditions for the graphitization treatment are as follows: the temperature is maintained at 2850° C. for 3.5 h, and then the temperature is increased to 2900° C. by 10° C./min and maintained for 3 h; and for the carbonization treatment, the temperature is 1310° C. and the time period is 4 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 8

Embodiment 8 provides a lithium ion battery, the method for preparing which is substantially the same as that of Embodiment 1, except that:
in preparing the negative plate, the anode active material is prepared by the following method that: natural graphite ore is used to obtain natural flake graphite through a crushing-ball milling-flotation step, and after screening, acid washing treatment and spheronization treatment, isostatic pressing treatment is carried out, and the conditions for the isostatic pressing treatment are as follows: a temperature of 170° C., a pressure of 80 MPa, and a time period of 60 min; the product after isostatic pressing is mixed with high-purity asphalt according to a mass ratio of 98:2, and the mixture is subjected to the carbonization treatment, wherein for the carbonization treatment, the temperature is 780° C. and the time period is 6.5 h; then screening and grading are performed to obtain D_{V}50 and D_{FW} that satisfy the anode active material described in table 1;
the rolling conditions are adjusted so that the PD of the negative plate satisfies Table 1.

### Embodiment 9

Embodiment 9 provides a lithium ion battery, the method for preparing which is substantially the same as that of Embodiment 1, except that:
in preparing the negative plate, the conditions for the graphitization treatment are as follows: the temperature is maintained at 2610° C. for 3 h, and then the temperature is increased to 2900° C. by 15° C./min and maintained for 3 h; and for the carbonization treatment, the temperature is 1350° C. and the time period is 4 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 10

Embodiment 10 provides a lithium ion battery, the method for preparing which is substantially the same as that of Embodiment 1, except that:
in preparing the negative plate, the anode active material is prepared by the following method that: natural graphite ore is used to obtain natural flake graphite through a crushing-ball milling-flotation step, and after screening, acid washing treatment and spheronization treatment, isostatic pressing treatment is carried out, and the conditions for the isostatic pressing treatment are as follows: a temperature of 200° C., a pressure of 75 MPa, and a time period of 90 min; the product after isostatic pressing is mixed with high-purity asphalt according to a mass ratio of 99:1, and the mixture is subjected to the carbonization treatment, wherein for the carbonization treatment, the temperature is 1280° C. and the time period is 6 h; then screening and grading are performed to obtain D_{V}50 and D_{FW} that satisfy the anode active material described in table 1;
the rolling conditions are adjusted so that the PD of the negative plate satisfies Table 1.

### Embodiment 11

Embodiment 11 provides a lithium ion battery, the method for preparing which is substantially the same as that of Embodiment 1, except that:
in preparing the negative plate, the conditions for the graphitization treatment are as follows: the temperature is maintained at 2600° C. for 4 h, and then the temperature is increased to 2750° C. by 15° C./min and maintained for 2 h; and for the carbonization treatment, the temperature is 840° C. and the time period is 4 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 12

Embodiment 12 provides a lithium ion battery, the method for preparing which is substantially the same as that of Embodiment 1, except that:
in preparing the negative plate, the conditions for the graphitization treatment are as follows: the temperature is maintained at 3000° C. for 3 h, and then the temperature is increased to 3100° C. by 10° C./min and maintained for 3 h; and for the carbonization treatment, the temperature is 830° C. and the time period is 8 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 13

Embodiment 13 provides a lithium ion battery, the method for preparing which is substantially the same as that of Embodiment 1, except that:
in preparing the negative plate, the conditions for the graphitization treatment are as follows: the temperature is maintained at 3200° C. for 3.5 h, and then the temperature is increased to 3280° C. by 8° C./min and maintained for 2.5 h; and for the carbonization treatment, the temperature is 1010° C. and the time period is 4 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 14

Embodiment 14 provides a lithium ion battery, the method for preparing which is substantially the same as that of Embodiment 1, except that:
in preparing the negative plate, the conditions for the graphitization treatment are as follows: the temperature is maintained at 3100° C. for 3 h, and then the temperature is increased to 3260° C. by 8° C./min and maintained for 3 h; and for the carbonization treatment, the temperature is 1070° C. and the time period is 7.5 h;
the artificial graphite is screened and graded so that the D_{V}50 and D_{FW} of the anode active material satisfy table 1; and
the rolling conditions are adjusted so that the PD of the negative plate satisfies Table 1.

### Embodiment 15

Embodiment 15 provides a lithium ion battery, the method for preparing which is substantially the same as that of Embodiment 1, except that:
in preparing the negative plate, the conditions for the graphitization treatment are as follows: the temperature is maintained at 3050° C. for 3 h, and then the temperature is increased to 3200° C. by 10° C./min and maintained for 3 h; and for the carbonization treatment, the temperature is 1250° C. and the time period is 6 h;
the artificial graphite is screened and graded so that the D_{V}50 and D_{FW} of the anode active material satisfy table 1; and
the rolling conditions are adjusted so that the PD of the negative plate satisfies Table 1.

### Comparative Example 1

Comparative Example 1 provides a lithium ion battery, the method for preparing which is substantially the same as that of Embodiment 1, except that:
in preparing the negative plate, the conditions for the graphitization treatment are as follows: the temperature is maintained at 2800° C. for 3 h, and then the temperature is increased to 3000° C. by 10° C./min and maintained for 4 h; and for the carbonization treatment, the temperature is 1000° C. and the time period is 4 h;
the artificial graphite is screened and graded so that the D_{V}50 and D_{FW} of the anode active material satisfy table 1; and
the rolling conditions are adjusted so that the PD of the negative plate satisfies Table 1.

### Comparative Example 2

Comparative Example 2 provides a lithium ion battery, the method for preparing which is substantially the same as that of Embodiment 1, except that:
in preparing the negative plate, the conditions for the graphitization treatment are as follows: the temperature is maintained at 2600° C. for 3 h, and then the temperature is increased to 2800° C. by 15° C./min and maintained for 3 h; and for the carbonization treatment, the temperature is 930° C. and the time period is 4.5 h;
the artificial graphite is screened and graded so that the D_{V}50 and D_{FW} of the anode active material satisfy table 1; and
the rolling conditions are adjusted so that the PD of the negative plate satisfies Table 1.

### Comparative Example 3

Comparative Example 3 provides a lithium ion battery, the method for preparing which is substantially the same as that of Embodiment 1, except that:
in preparing the negative plate, the conditions for the graphitization treatment are as follows: the temperature is maintained at 2640° C. for 2 h, and then the temperature is increased to 2760° C. by 15° C./min and maintained for 3.5 h; and for the carbonization treatment, the temperature is 1150° C. and the time period is 4 h;
the artificial graphite is screened and graded so that the D_{V}50 and D_{FW} of the anode active material satisfy table 1; and
the rolling conditions are adjusted so that the PD of the negative plate satisfies Table 1.

The D_{V}50 and D_{FW} of the anode active material, and La, PD, and Rᵢₒₙ values of the negative plate prepared in Embodiments and Comparative Examples are shown in Table 1.

TABLE 1

| | D_{FW} | Dv50 | La | PD | a/ | Rᵢₒₙ | 5.5 × |
|---|---|---|---|---|---|---|---|
| | (μm) | (μm) | (nm) | (g/cm³) | 45-b | (Ω) | b-ln(c) |
| Embodiment 1 | 25.1 | 12 | 70 | 1.68 | 0.05 | 0.438 | 10.07 |
| Embodiment 2 | 17.2 | 13.4 | 69.4 | 1.68 | 0.06 | 0.525 | 9.88 |
| Embodiment 3 | 15.5 | 14.9 | 65.1 | 1.65 | 0.08 | 0.623 | 9.55 |
| Embodiment 4 | 30 | 11.5 | 73 | 1.65 | 0.10 | 0.496 | 9.78 |
| Embodiment 5 | 29.5 | 10.1 | 74.5 | 1.61 | 0.12 | 0.079 | 11.39 |
| Embodiment 6 | 21.6 | 13.2 | 70.2 | 1.6 | 0.15 | 0.229 | 10.27 |
| Embodiment 7 | 29.8 | 15 | 72.3 | 1.62 | 0.18 | 0.529 | 9.55 |
| Embodiment 8 | 34.7 | 8.2 | 73.7 | 1.6 | 0.08 | 0.244 | 10.21 |
| Embodiment 9 | 10.2 | 19.9 | 60.2 | 1.6 | 0.15 | 0.375 | 9.78 |
| Embodiment 10 | 28.2 | 16.1 | 80 | 1.72 | 0.15 | 0.862 | 9.61 |
| Embodiment 11 | 33 | 5.2 | 51.2 | 1.33 | 0.08 | 0.11 | 9.52 |
| Embodiment 12 | 28.5 | 18.5 | 74.4 | 1.8 | 0.06 | 0.963 | 9.94 |
| Embodiment 13 | 24.3 | 17.6 | 78 | 1.74 | 0.13 | 0.052 | 12.53 |
| Embodiment 14 | 25 | 18.2 | 77.1 | 1.75 | 0.13 | 0.66 | 10.04 |
| Embodiment 15 | 25.2 | 17.8 | 77.6 | 1.75 | 0.13 | 1.899 | 8.98 |
| Comparative | 17.5 | 13.0 | 68.1 | 1.7 | 0.03 | 1.694 | 8.82 |
| Example 1 | | | | | | | |
| Comparative | 37 | 7.8 | 54.8 | 1.51 | 0.02 | 0.136 | 10.30 |
| Example 2 | | | | | | | |
| Comparative | 11.2 | 19.9 | 58.8 | 1.71 | 0.03 | 0.375 | 10.39 |
| Example 3 | | | | | | | |

The surface states of the negative plates prepared in the Embodiments and Comparative Examples are observed, the contact angles of the negative plates are measured, and the cycle lives of the lithium ion batteries prepared in the Embodiments and Comparative Examples are measured, and the results are shown in Table 2.

TABLE 2

| | | contact | cycle |
|---|---|---|---|
| | surface state | angle (°) | life |
| Embodiment 1 | good surface | 62.7 | 3765 |
| Embodiment 2 | good surface | 61.6 | 3790 |
| Embodiment 3 | good surface | 60.1 | 3850 |
| Embodiment 4 | good surface | 56.3 | 4015 |
| Embodiment 5 | good surface | 51.9 | 4120 |
| Embodiment 6 | good surface | 50.4 | 4160 |
| Embodiment 7 | good surface | 49.9 | 4195 |
| Embodiment 8 | good surface | 60.7 | 3815 |
| Embodiment 9 | good surface | 50.8 | 4135 |
| Embodiment 10 | good surface | 51.5 | 4120 |
| Embodiment 11 | good surface | 61.4 | 3800 |
| Embodiment 12 | good surface | 62.3 | 3775 |
| Embodiment 13 | good surface | 46.9 | 3980 |
| Embodiment 14 | good surface | 53.2 | 4050 |
| Embodiment 15 | good surface | 57.0 | 3875 |
| Comparative | edge | 71.5 | 3010 |
| Example 1 | overpressure | | |
| Comparative | severe | 88.2 | 2490 |
| Example 2 | overpressure | | |
| Comparative | edge | 74.4 | 2840 |
| Example 3 | overpressure | | |

From combination of the test results in Tables 1 and 2, it can be seen that when the negative plates meet the requirements of a/45−b≥0.05, they all have a lower wetting angle, indicating that the negative plates maintain good wetting performance at a low temperature and have a higher cycle life; however, when the value of a/45−b of the negative plate is less than 0.05, the wettability of the material is deteriorated, and the cycle life is also decreased, and after the negative plates prepared in Comparative Examples 1-3 are subjected to rolling, the surfaces of the negative plates show various degrees of overpressure.

According to Embodiments 1 to 7, the values of a/45−b are higher, and the wetting angles of the negative plates tend to decrease, indicating that the wetting performance of the plates is better. However, the value of a/45−b should not be too high, which may cause a decrease in the energy density of the battery (for example, when the value of a/45−b of the negative plate is 0.2, the energy density of the battery decreases by about 5% compared to Embodiment 1), or the charge/discharge rate of the battery is impaired.

According to Embodiments 8-12, when the D_{V}50 and D_{FW} of the anode active material or the La and PD of the negative plate are in a non-preferred range, the wetting angle and the cycle life of the negative plate are deteriorated to some extent.

According to Embodiments 13 to 15, it can be seen that in the case where the values of a/45-b of the negative plates are close or the same, the lower the ion transport impedance (c value), the contact performance of the negative plates is relatively better, and when the negative plate satisfies a 5.5×b−ln(c) of 9.5-11.5, the negative plate has excellent wetting performance and excellent cycle life of the battery is also ensured.

Finally, it should be noted that the above-mentioned embodiments are merely illustrative of the technical solution of the present disclosure, and are not restrictive of the scope of protection of the present disclosure. Although the present disclosure has been described in detail with reference to the foregoing preferred embodiments, a person skilled in the art will appreciate that the technical solutions of the present disclosure can be amended or replaced with equivalents without departing from the essence and scope of the technical solutions of the present disclosure.

What is claimed is:

1. A negative plate, including a negative current collector and an anode active material layer provided on at least one surface of the negative current collector, the anode active material layer including an anode active material, wherein the anode active material includes graphite, and the negative plate satisfies the following relationship:
$$a = ln ( {D}_{F W} ) + 10 \times ln ( {D}_{V} 50 ) + 1 / 3 ( L a ) + 26.5 , b = P D , a / 45 - b \geq 0.05 ,$$
where D_{FW} is a full width at half maximum of a particle size volume distribution of the anode active material in a unit of μm,
D_{V}50 is a particle diameter corresponding to 50% of a cumulative volume distribution percentage of the anode active material in a unit of μm,
La is an average size of a crystal in an a-axis direction measured by Raman spectroscopy on the negative plate in a unit of nm, and
PD is a compacted density of the negative plate in a unit of g/cm³.

2. The negative plate according to claim 1, wherein the negative plate satisfies the following relationship: 0.06≤a/45−b≤0.15.

3. The negative plate according to claim 1, wherein the D_{FW} is in a range of 10 μm to 35 μm.

4. The negative plate according to claim 3, wherein the D_{FW} is in a range of 15 μm to 30 μm.

5. The negative plate according to claim 1, wherein the D_{V}50 is in a range of 5 μm to 20 μm.

6. The negative plate according to claim 5, wherein the D_{V}50 is in a range of 10 μm to 15 μm.

7. The negative plate according to claim 1, wherein the La is in a range of 50 nm to 80 nm.

8. The negative plate according to claim 7, wherein the La is in a range of 65 nm to 75 nm.

9. The negative plate according to claim 1, wherein the PD is in a range of 1.3 g/cm³ to 1.8 g/cm³.

10. The negative plate according to claim 9, wherein the PD is in a range of 1.60 g/cm³ to 1.75 g/cm³.

11. The negative plate according to claim 1, wherein the negative plate further satisfies the following relationship: 9.5≤5.5×b−ln(c)≤11.5,
where c is an ion transport impedance of the negative plate in a unit of ohms (Ω).

12. The negative plate according to claim 11, wherein the c is in a range of 0.05Ω to 2Ω.

13. The negative plate according to claim 12, wherein the c is in a range of 0.1Ω to 1.0Ω.

14. A secondary battery, including a positive plate, a negative plate and an electrolyte solution, wherein the negative plate is the negative plate according to claim 1.

15. An electrical device, comprising the secondary battery according to claim 14.
